(19) United States
(12) Patent Application Publication
(10) Pub. No.: US 2022/0039138 A1
(43) Pub. Date: Feb. 3, 2022

(54) USER TERMINAL AND RADIO COMMUNICATION METHOD

(71) Applicant: NTT DOCOMO, INC., Tokyo (JP)

(72) Inventors: Kazuki Takeda, Tokyo (JP); Satoshi Nagata, Tokyo (JP); Lihui Wang, Beijing (CN); Xiaolin Hou, Beijing (CN)

(73) Assignee: NTT DOCOMO, INC., Tokyo (JP)

(21) Appl. No.: 17/312,261

(22) PCT Filed: Dec. 11, 2018
(86) PCT No.: PCT/JP2018/045522

§ 371 Date: Jun. 9, 2021

(51) Int. Cl. H04W 72/12; H04L 5/00; H04L 12/18

(52) U.S. Cl. CPC H04W 72/1289; H04L 12/189; H04L 5/0048

(57) ABSTRACT

A user terminal includes: a receiving section that receives at least one signal of a combination of at least one of broadcast data and multicast data and unicast data, control information, and a reference signal in accordance with traffic that aperiodically occurs; and a control section that decodes at least one message from the at least one signal. According to one aspect of the present disclosure, information can be appropriately transmitted in response to the occurrence of traffic.

### TECHNICAL FIELD

The present disclosure relates to a user terminal and a radio communication method in a next-generation mobile communication system.

### BACKGROUND ART

In a universal mobile telecommunications system (UMTS) network, long term evolution (LTE) has been specified for the purpose of further high-speed data rate, low-delay, and the like (see Non-Patent Literature 1). LTE-Advanced (3GPP Rel. 10 to 14) has been specified for the purpose of further larger capacity and sophistication of LTE (third generation partnership project (3GPP) release (Rel.) 8, 9),

Successor systems to LTE (e.g., also referred to as 5th generation mobile communication system (5G), 5+ (plus), new radio (NR), and 3GPP Rel. 15 or later) are considered.

In an existing LTE system (e.g., LTE Rel. 13, hereafter also simply noted as LTE), everything (e.g., object including a sensor and a communication function) is connected to the Internet. Machine type communication (MTC) and narrow band Internet of Things (NB-IoT) have been specified as Internet of Things (IoT) that exchanges various pieces of data (e.g., measurement data, sensor data, and control data).

In MTC, uplink (UL) or downlink (DL) communication is performed by using a bandwidth (e.g., 1.4 MHz) narrower than the maximum bandwidth (e.g., 20 MHz) per cell (also referred to as serving cell, component carrier (CC), carrier, and the like) of LTE as the maximum bandwidth MTC is also called LTE-MTC (LTE-M), enhanced MTC (eMTC), low-cost-MTC (LC-MTC), and the like.

In NB-IoT, for example, UL or DL communication is performed by sing a bandwidth (e.g., 200 kHz) narrower than the maximum bandwidth of MTC as the maximum bandwidth NB-IoT is also called narrow band LTE (NB-LTE), narrow band cellular Internet of Things (NB cellular IoT), clean slate, and the like.

### CITATION LIST

### Non Patent Literature

Non Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8)”, April, 2010

### SUMMARY OF INVENTION

### Technical Problem

Future radio communication systems (e.g., NR) are expected to involve use cases such as an enhanced mobile broadband (eMBB), machine type communications that embodies multiple simultaneous connection (massive machine type communications (mMTC), Internet of Things (mIoT), and massive Internet of Things (mIoT)), and ultra-reliable and low-latency communications (URLLC).

Unfortunately, when such radio communication is used in a system that is susceptible to delay time, such us for industrial use, the performance of the system may deteriorate if information cannot be appropriately transmitted in response to the occurrence of traffic.

One object of the present disclosure is to provide a user terminal and a radio communication method for appropriately transmitting information in response to the occurrence of traffic.

### Solution to Problem

A user terminal according to one aspect of the present disclosure includes: a receiving section that receives at least one signal of a combination of at least one of broadcast data and multicast data and unicast data, control information, and a reference signal in accordance with traffic that aperiodically occurs; and a control section that decodes at least one message from the at least one signal.

### Advantageous Effects of Invention

According to one aspect the present disclosure, information can be appropriately transmitted in response to the occurrence of traffic.

### BRIEF DESCRIPTION OF DRAWINGS

FIG. 1 illustrates one example of a procedure of processing aperiodic traffic.

FIGS. 2A and 2B illustrate examples of the contents of group common DCI.

FIG. 3 illustrates one example of two messages in accordance with the aperiodic traffic.

FIG. 4 illustrates one example of a schematic configuration of a radio communication system according to one embodiment.

FIG. 5 illustrates one example of the configuration of a base station according to one embodiment.

FIG. 6 illustrates one example of the configuration of a user terminal according to one embodiment.

FIG. 7 illustrates one example of the hardware configuration of a base station and a user terminal according to one embodiment.

### DESCRIPTION OF EMBODIMENTS

<MTC/IoT>

In MTC, a peak rate is expected to be lower than that of LTE before Rel. 12. For example, the peak rates of downlink (DL) and uplink (UL) in MTC are assumed to be 1 Mbps.

In MTC, communication is performed by using a band narrower than the maximum system band (e.g., 20 MHz) of LTE before Rel. 12 as the maximum bandwidth. For example, the maximum bandwidth per component carrier (also referred to as CC, cell, serving cell, carrier, system bandwidth, and the like) of LTE before Rel. 12 is 20 MHz while the maximum bandwidth of MTC may be, for example, 1.4 MHz and MHz.

When sub-carrier spacing (SCS) is 15 kHz, six resource block (physical resource block (PRE)) may constitute 1.4 MHz. The band for MTC is also called a narrow band (NB), and may be identified by a given index (e.g., narrow band index).

MTC is also called enhanced MTC (eMTC), LTE-MTC (LTE-M), LTE-M1, low cost-MTC (LC-MTC), and the like. Devices that perform MTC. is also called an MTC terminal, user equipment (UE), a user terminal, a terminal, an apparatus, MTC UE, UE (BL/CE UE) of at least one of bandwidth reduced Low complexity (BL) and coverage enhancement (CE), BL UE, UE of enhanced coverage, and the like.

The MTC terminal monitors (performs blind decoding on) candidates (also referred to as search space and the like) of a downlink control channel (e.g., machine type communication physical downlink control channel (MPDCCH), enhanced physical downlink control channel (EPDCCH), and in simple terms, physical downlink control channel (PDCCH) and the like), and detects downlink control information (DCI). A. resource unit (also referred to as control channel element (CCE) and enhanced CCE (ECCE)) of the number in accordance with an aggregation level constitutes each candidate of MPDCCH.

DCI for MTC may include, for example, DCI (UL grant, for example, DCI format 6-0A. or 6-0B) used for scheduling of an uplink shared channel (e.g., physical uplink shared channel (PUSCH)), DCI (DL assignment, for example, DCI format 6-1A or 6-1B) used for scheduling of a downlink shared channel (e.g., physical downlink shared channel (PDSCH)), and DCI (e.g., DCI format 6-2) used for paging and the like.

The MTC terminal may control the reception of PDSCH allocated in a given unit (e.g., PRB unit) in a narrow hand based on DCI (e.g., DCI format 6-1A or 6-1B). Similarly, the MTC terminal may control the transmission of PUSCH allocated in a given unit (e.g., PRB unit or subcarrier unit) in a narrow band based on DCI (e.g., DCI format 6-0A or 6-0B).

The MTC terminal may receive a synchronization signal (SS) and a broadcast channel (physical broadcast channel (PBCH)) transmitted at 1.4 MHz (6 PRB) from the center frequency of a cell, receive a system information block (SIB) at 1.4 MHz based on a master information block (MIB) transmitted by PBCH, and start a random access procedure based on the SIB. The SS may include a primary synchronization signal (PSS) and a secondary synchronization signal (SSS).

In contrast, in NB-IoT, a peak rate is expected to be lower than that in MTC. For example, in NB-IoT, the peak rate of downlink (DL) is expected to be 200 kbps, and that of uplink (UL) is expected to be 144 kbps. In NB-IoT, communication is performed with a maximum bandwidth of 200 kHz. When sub-carrier spacing is 15 kHz, 1 PRB may constitute 200 kHz. A device that performs NB-IoT is also called an NB-IoT terminal, UE, a user terminal, a terminal, an apparatus, NB-IoT UE, and the like.

The NB-IoT terminal monitors (performs blind decoding on) candidates (also referred to as search space and the like) of a down ink control channel (e.g., narrowband physical downlink control channel (NPDCCH), and in simple terms, PDCCH and the like) for NB-IoT, and detects DCI. A resource unit (also referred to as CCE, narrowband CCE (NCCE), and the like) of the number in accordance with an aggregation level constitutes each candidate of NPDCCH.

DCI for NB-IoT may include, for example, DCI (UL grant, for example, DCI format NO) used for scheduling of an uplink shared channel (e.g., narrowband physical uplink shared channel (NPUSCH) and in simple terms, PUSCH and the like) for NB-IoT, DCI (DL assignment, for example, DCI format N1) used for scheduling of a downlink shared channel (e.g., narrowband physical downlink shared channel (NPDSCH) and in simple terms, PDSCH and the like) for NB-IoT, and DCI (e.g., DCI format N2) used for paging and the like.

The NB-IoT terminal may control the reception of NPDSCH allocated in a given unit (e.g., one or more subcarrier units) in a narrow band based on DCI (e.g., DCI format N1). Similarly, the NB-IoT terminal may control the transmission of NPUSCH allocated in a given unit (e.g., one or more subcarrier units) in a narrow band based on DCI (e.g., DCI format N0).

The subcarrier may be called a tone and the like. Transmission of NPDSCH or NPUSCH using a single subcarrier may be called single tone transmission. Transmission of NPDSCH or NPUSCH using a plurality of subcarriers may be called multitone transmission.

The NB-IoT terminal cannot detect PSS, SSS, and PBCH transmitted at 1.4 MHz (6 PRB). For this reason, a synchronization signal (narrowband synchronization signal (NSS)) and a broadcast channel (narrowband physical broadcast channel (NPBCH)) for an NB-IoT terminal ma be transmitted at 1 PRB (200 kHz or 180 kHz). For e,ample, NPSS and NPBCH may be transmitted in 10 subframe periods, and NSSS may be transmitted in 20 subframe periods. NSS may include a primary synchronization signal (narrowband primary synchronization signal (NPSS)) and a secondary synchronization signal (narrowband secondary synchronization signal (NSSS)) for an NB-IoT terminal.

The NB-IoT terminal may receive NSS and NPBCH, receive SIB a 1 PRB (200 kHz or 180 kHz) based on MIB transmitted by NPBCH, and start a random access procedure based on the SIB. In the random access procedure, the NB-IoT terminal may transmit PRACH (also referred to as narrowband physical random access channel (NPRACH), NPRACH preamble, and the like) for the NB-IoT terminal by using a subcarriers with given sub-carrier spacing (e.g., 3.75 kHz). MIB for an NB-IoT terminal may be called an MIB-Narrowband (NB) and the like. SIB for an NB-IoT terminal may be called SIB-NB and the like.

<Acquisition of System Information Using Paging>

In LTE, system information change notification using paging information (paging message) is supported for a user terminal in an RRC connected state (RRC_CONNECTED) and a user terminal in an RRC idle state (RRC_IDLE). The system information change not using paging information (paging message) is also supported in NR. In NR, the system information change notification using paging information (paging message) can be given for each of a user terminal in the RRC connected state (RRC_CONNECTED), a user terminal in the RRC idle state (RRC_IDLE), and a user terminal in an RRC inactive state (RRC_INACTIVE).

In NR, UE in the RRC idle state or the RRC inactive state (RRC_INACTIVE) performs discontinuous reception (DRX) in a certain periodicity for reducing power consumption. The UE monitors one paging occasion (PO) for each DRX cycle.

Here, PO is a set of monitoring occasions (period for monitoring and PDCCH monitoring opportunity) of a downlink control channel (e.g., PDCCH). One or more time domain resource units (e.g., one or more slots, one or more subframes, and one or more symbols) may constitute PO.

In DO, downlink control information (DCI) (DCI for paging, paging DCI, and DCI format 1_0) for scheduling a downlink shared channel (e.q., PDSCH) for transmitting a paging message is transmitted. The paging DCI may have a cyclic redundancy check (CRC) bit scrambled by a given paging-radio network temporary identifier (P-RNTI). When downlink control information scrambled by P-RNTI is detected in CRC, a user terminal can determine that the downlink control information corresponds to paging DCI that schedules PDSCH that transmits the paging message.

One paging frame (PF) is one radio frame, and may include one or more POs. PF may also be a starting point of PO. Each radio frame may be identified with a system frame number (SFN).

In the PRC connected state (RRC_CONNECTED), when provided with common search space (paging search space) for monitoring paging, the UE monitors the paging DCI in at least one PO within a system information change period.

UE receives an instruction for at least one of system information change and public warning system (PWS) notification based on a short message transmitted by the paging DCI.

The system information may include an earthquake and tsunami warning system (ETWS), commercial mobile alert service (CMAS), and extended access barring (EAB).

LTE, SIB10 (SystemuInformationBlockType10) includes primary notification (brief notification) of ETWS, and SIB11 (SystemuInformatoinBlockType11) includes secondary notification (detailed information) of ETWS.

In NR, SIB6 includes primary notification of ETWS, and SIB7 includes secondary notification of ETWS.

<Time Sensitive Networking (TSN)>

Industrial radio communication service is considered. The service may be used for use cases such as remote control of a plurality of devices (e.g., robots, factories, and machine tools) and synchronization of a plurality of devices.

In TSN requirements for such service, supporting the next traffic type is considered.

A plurality of periodic streams with different periods and critical priority (e.g., plurality of TSN streams)

Aperiodic critical priority traffic, which is a result of a critical event (e.g., alarms and safety detectors)

Best effort type of traffic (e.g., eMBB traffic)

In contrast, reliability of traffic for unicast data is mainly considered as enhanced ultra reliable and low latency communications (eURLLC).

Details of aperiodic traffic, however, has not been clarified. If the aperiodic traffic cannot be properly handled, communication requirements (e.g., TSN requirements) may fail to be satisfied.

The present inventors have conceived a method in which a user terminal appropriately receives or transmits a message in accordance with aperiodic traffic.

Hereinafter, embodiments according to the present disclosure will be described in detail with reference to the drawings. A radio communication method according to each of the embodiments may be applied independently, or may be applied in combination with others.

A case (downlink) where a transmitting apparatus that transmits a message in accordance with an event is a base station and a receiving apparatus that receives the message is UE will be described below. The present invention may be applied to a case (uplink) where the transmitting apparatus is UE and the receiving apparatus is a base station or a case (side link) where the transmitting apparatus is UE and the receiving apparatus is other UE.

The base station may be replaced with a master node, a network (NW), a controller, gNB, eNB, and the like. UE may be replaced with a secondary node, a device, and the like. The controller may control a plurality of devices.

An event may be replaced with a specific event, a critical event, an error, an emergency, an alarm, a safety detector, and the like.

(Radio Communication Method)

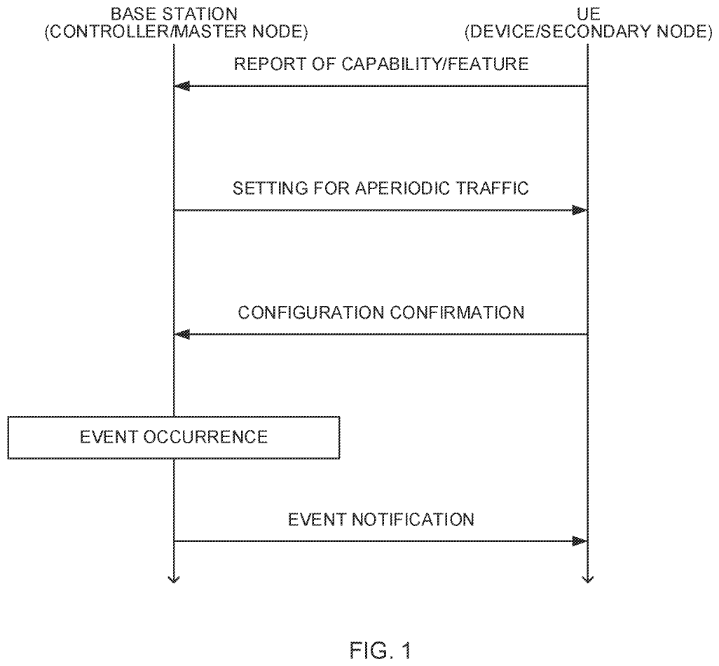

FIG. 1 illustrates one example of a procedure of processing aperiodic traffic. Here, aperiodic traffic from a base station to UE will be described.

In S10, in order to inform the base station that the UP is a terminal that needs support of aperiodic traffic for Industrial Internet of Things (IIoT), the UE may report at least one of capability and feature. The report information may be higher layer signaling composed of one or more bits for reporting that the UE is one terminal classified as an IIOT terminal. The report information may include the type of aperiodic traffic to be supported (e.g., packet size (or data size and transport block size) of aperiodic traffic), transmission/reception antenna information by which the aperiodic traffic can be transmitted/received, a frequency band in which the aperiodic traffic can be transmitted/received, sub-carrier spacing in which the aperiodic traffic can be used, a bandwidth, a monitoring period of a downlink control channel (PDCCH) in which the aperiodic traffic can be scheduled, and the type of a data channel through which the aperiodic traffic can be transmitted (e.g., broadcast data, multicast data, and unicast data).

In S20, the base station that has received the report transmits settings related to a channel (container) used for transmitting the aperiodic traffic and settings related to information (content) to be transmitted as the aperiodic traffic to the UE. Here, the base station may transmit the settings to the UE by higher layer signaling (e.g., RRC signaling).

The base station may set at least one of the followings for the aperiodic traffic.

Container: which may be PDSCH, PDCCH, RS, and settings thereof.

Content: which may be information (message) transmitted by PDSCH or PDCCH.

Identifier: which may be a specific RNTI or a group UE-ID.

Settings for the aperiodic traffic may be communicated to UE by system information (SIB-x) having a given index x or UE specific RRC signaling.

When the settings for the aperiodic traffic are communicated by the UE specific RRC signaling, the UE may transmit a configuration confirmation (configuration complete) message in 530.

When detecting an event, the base station that has received the configuration confirmation transmits information (broadcast or multicast and unicast) related to the event by using a set identifier and a set container in S40.

### First Embodiment

UE may receive a container for aperiodic traffic used for a critical event. The container may be at least one of the following options 1-1 to 1-3.

«Option 1-1»

The aperiodic traffic is at least one of unicast data, broadcast data, and multicast data, and the container thereof may be, for example, PDSCH. UE may receive at least one of unicast data, broadcast data, and multicast data by using PDSCH as a container and as the aperiodic traffic used for a critical event.

The aperiodic traffic may be a combination of these pieces of data For example, the aperiodic traffic may be at least one of the following options 1-1-1 and 1-1-2.

«Option 1-1-1»

The aperiodic traffic may be unicast data (UE specific signaling) and broadcast data (cell common signaling).

New broadcast signaling may be specified for the aperiodic traffic. The broadcast signaling may be similar to SIB10 and SIB11 of LTE, and may be similar to SIB6 and SIB7 of NR. In other words, UE may receive broadcast signaling by receiving system information based on paging.

Unicast data and broadcast data may be scheduled by DCI having CRC scrambled by the same RNTIs. The RNTI may be given RNTI set common to cells (e.g., RNTI for system information (e.g., system information (SI)-RNTI)). The user terminal monitors the DCI in which CRC is scrambled by the given RNTI (e.g., SI-RNTI). When the DCI that schedules the aperiodic traffic is detected, the user terminal performs reception detection operation assuming that the PDSCH includes the aperiodic traffic regardless of whether PDSCH scheduled by the DCI is unicast data or broadcast data. PDSCH including the unicast data and the broadcast data may include CRC scrambled by the same RNTI. PDSCH including the unicast data may include CRC scrambled by RNTI (e.g., C-RNTI, MCS-C-RNTI, and CS-RNTI) set in a user specific manner. PDSCH including the broadcast data may include CRC scrambled by RNTI (e.g., SI-RNTI) common to users.

The unicast data and the broadcast data may be scheduled by DCI having CRC scrambled by different RNTIs. RNTI for the broadcast data may be RNTI (e.g., SI-RNTI) set in common to cells. RNTI for the broadcast data may be another RNTI (e.g., another SI-RNTI) set in common to cells. RNTI for the unicast data may be RNTI (e.g., C-RNTI, MCS-C-RNTI, or CS-RNTI) set in a UP specific manner. The user terminal monitors the DCI in which CRC is scrambled by the given RNTI. When the DCI that schedules the aperiodic traffic is detected, the user terminal performs reception detection operation assuming that the PDSCH includes the aperiodic traffic regardless of whether PDSCH scheduled by the DCI is unicast data or broadcast data. PDSCH including the unicast data and the broadcast data may include CRC scrambled by the same RNTI. PDSCH including the unicast data may include CRC scrambled by RNTI (e.g., C-RNTI, MCS-C-RNTI, and CS-RNTI) set in a user specific manner. PDSCH including the broadcast data may include CRC scrambled by RNTI (e.g., SI-RNTI) common to users.

All pieces of UE which receive the broadcast data may receive the unicast data, or some pieces of UE which receive the broadcast data may receive the unicast data. For example, the broadcast data may give an instruction to stop. The unicast data may relate to UP specific control or control over a group smaller than UE that receives broadcast data.

When receiving the aperiodic traffic as the unicast data, the user terminal may provide HARQ-ACK feedback.

The base station may transmit settings of each of the broadcast data and the unicast data (e.g., settings related to the above-described container, contents, and identifier) to UE by higher layer signaling based on capability information reported by UE.

After the setting, UE may receive cell common DCI for scheduling cell common PDSCH, and may receive cell common PDSCH that carries the broadcast data based on the DCI. After the setting UE may receive UE specific DCI for scheduling UE specific PDSCH, and may receive UE specific PDSCH that carries the unicast data based on the DCI.

According to the option 1-1-1, data is transmitted without using paging in response to the occurrence of aperiodic traffic, so that the delay time from the occurrence to the transmission of the aperiodic traffic can be inhibited. Control of a specific transmission destination and control in which a plurality of transmission destinations is synchronized can be performed by transmitting specific data to one transmission destination and transmitting common data to a plurality of transmission destinations.

«Option 1-1-2»

The aperiodic traffic may be unicast data (UE specific signaling) and multicast data (group common signaling).

The base station may set the reception of the aperiodic traffic with the unicast data and the multicast data for a part or all of a specific type of UE (UE that has reported specific capability information). In order to receive PDSCH for transmitting at least the multicast data, a UE group to which the aperiodic traffic is set may receive PDCCH common to UE groups, and receive PDSCH common to the UE groups. RNTI used for scrambling PDSCH may be used for scrambling CRC in corresponding PDCCH. The RNTI may be set with a parameter different from SI-RNTI and C-RNTI.

The unicast data and the multicast data may be scheduled by DCI having CRC scrambled by the same RNTIs. The RNTI may be given (set for UE group) for a group common DCI. The given RNTI may be RNTI configured for the UE group, such as slot format indicator (SFI)-RNTI, interruption (INT)-RNTI, transmission power control (TPC)-PUSCH-RNTI, TPC-PUCCH-RNTI, and TPC-SRS-RNTI, or may be RNTI of type different therefrom. The user terminal monitors the DCI in which CRC is scrambled by the given RNTI. When the DCI that schedules the aperiodic traffic is detected, the user terminal performs reception detection operation assuming that the PDSCH includes the aperiodic traffic regardless or whether PDSCH scheduled by the DCI is unicast data or multicast data. PDSCH including the unicast data and the multicast data may include CRC scrambled by the same RNTI. PDSCH including the unicast data may include CRC scrambled by RNTI (e.g., C-RNTI, MCS-C-RNTI, and CS-RNTI) set in a user specific manner. PDSCH including the multicast data may include CRC scrambled by RNTI common to groups.

The unicast data and the multicast data may be scheduled by DCI having CRC scrambled by different RNTIs. The RNTI for the multicast data may be given (set for UE group) for a group common DCI. The given RNTI may be RNTI set for the UE group, such as SFI-RNTI, INT-RNTI, TPC-PUSCH-RNTI, TPC-PUCCH-RNTI, and TPC-SRS-RNTI, or may be RNTI of type different therefrom RNTI for the unicast data may be RNTI (e.g., c-RNTI, MCS-C-RNTI, or CS-RNTI) set in a UE specific manner. The user terminal monitors the DCI in which CRC is scrambled by the given RNTI. When the DCI that schedules the aperiodic traffic is detected, the user terminal performs reception detection operation assuming that the PDSCH includes the aperiodic traffic regardless of whether PDSCH scheduled by the DCI is unicast data or multicast data. PDSCH including the unicast data and the multicast data may include CRC scrambled by the same RNTI. PDSCH including the unicast data may include CRC scrambled by RNTI (e.g., C-RNTI, MCS-C-RNTI, and CS-RNTI) set in a user specific manner. PDSCH including the multicast data may include CRC scrambled by RNTI common to groups.

All pieces of UE which receive the multicast data may receive the unicast data, or some pieces of UE which receive the multicast data may receive the unicast data. For example, the multicast data may give an instruction to stop. The unicast data may relate to UE specific control or control over a group smaller than a UE group at receives multicast data.

When receiving the aperiodic traffic as the unicast data, the user terminal may provide HARQ-ACH feedback.

When receiving the multicast data, the user terminal may report the decoding result (ACK or PACK) as HARQ-ACK. The UE may be set with giving feedback about HARQ-ACK to the multicast data by higher layer signaling, and may be set with information necessary for the HARQ-ACK feedback (e.g., PUCCH format, PUCCH resources, and applicability of ACK/NACK bundling). The base station can recognize UE that has failed to receive the multicast data by the UE transmitting, HARQ-ACK to the multicast data.

Some UE among a plurality of pieces of UE to which reception of the multicast data is set may be set with giving feedback about HARQ-ACK to the multicast data by higher layer signaling. The base station may set whether or not to transmit HARQ-ACK to the multicast data in UE based on the capability information reported by the UE. UE may determine whether or not to transmit HARQ-ACK to the multicast data based on the reported capability information. UE that has reported capability information indicating that service (communication requirements) that requires high reliability is supported and UE set with service that requires high reliability may transmit HARQ-ACK to the multicast data.

UE may be set with resources of HARQ-ACK to the multicast data by higher layer signaling, and determine resources of HARQ-ACK to the multicast data based on a specific parameter. The resources of HARQ-ACK to the multicast data may differ between pieces of UE to which the reception of the multicast data is set. The specific parameter may be UE-ID, C-RNTI, and the like.

The base station may transmit settings of each of the multicast data and the unicast data (e.g., settings related to the above-described container, contents, and identifier) to UE by higher layer g based on capability information reported by UE.

After the setting, UE may receive group common DCI for scheduling group common PDSCH, and may receive group common PDSCH that carries the multicast data based on the DCI. After the setting, UE may receive UE specific DCI for scheduling UE specific PDSCH, and may receive UE specific PDSCH that carries the unicast data based on the DCI.

According to the option 1-1-2 data is transmitted without using paging in response to the occurrence of aperiodic traffic, so that the delay time from the occurrence to the transmission of the aperiodic traffic can be inhibited. Control of a specific transmission destination and control in which a plurality of transmission destinations is synchronized can be performed by transmitting specific data to one transmission destination and transmitting common data to a plurality of transmission destinations.

The needs for setting the reception of aperiodic traffic to another piece of UE eliminated by setting the reception of the aperiodic traffic to specific UE (UE group), so that loads on the other UE can be inhibited.

«Option 1-2»

The container may be control information (control signaling and layer 1 (L1) signaling). UE may receive control information as a container for aperiodic traffic used for a critical event.

The control information may be at least one of UE-specific DCI, group common DCI, and cell common DCI.

A new RNTI may be specified for at least one of the group common DCI and the cell common DCT. A new DCI field or DCI content may be specified to announce the presence or absence of aperiodic traffic, an alarm, or an error.

The group common DCI may have at least one field or content of the following options 1-2-1 and 1-2-2.

«Option 1-2-1»

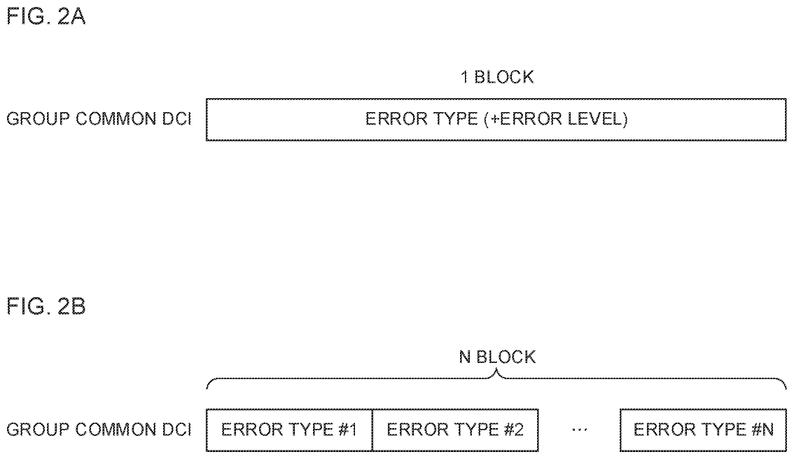

The field or content in the group common DCI may be common to a group of UE. As illustrated in FIG. 2A, the or content in the group common DCI may include only one block. That is, the group common DCI includes one field for announcing at least an error type, and the user terminal determines the error type in accordance with the value of the field. In addition to the error type, the group common DCI may include at least one of an error level and a field for determining UE operation in accordance with the error.

«Option 1-2-2»

The group common DCI may include two or more blocks. illustrated in FIG. 2B, each block includes one field that announces at least an error type. In addition to the error type, each block may include at least one of an error level and a field for determining UE operation in accordance with the error. Different blocks may be associated with different pieces of UE by higher layer signaling. Although UE monitors fields such as an error type, an error level, and UE operation in a block associated with UE itself, and determines the operation in accordance with the detection result, UE ignores all values of blocks that are not associated with UE itself.

The group common DCI in FIG. 2B includes error types #1, #2 . . . , and #N respectively corresponding to UE #1, #2 . . . , and #N in the UE group.

According to the option 1-2, control information is transmitted without using paging and scheduling in response to the occurrence of aperiodic traffic, so that the delay time from the occurrence to the transmission of the aperiodic traffic can be inhibited. When specific control information is transmitted to one transmission destination, a specific transmission destination can be controlled. When common control information is transmitted to a plurality of transmission destinations, control in which the plurality of destinations is synchronized can be performed.

«Option 1-3»

The container may be a specific reference signal (RS and reference signaling). UE may receive a specific RS as a container for aperiodic traffic used for a critical event.

The specific RS may be at least one of a channel state information (CSI)-RS, a primary synchronization signal (PSS), a secondary synchronization signal (SSS), a tracking reference signal (TRS), a phase tracking reference signal (PTRS), a demodulation reference signal (UMRS), a sounding reference signal (SRS), and a physical random access channel (PRACH).

The base station may transmit a specific RS having a specific sequence only when aperiodic traffic is transmitted. UE to which resources of the specific RS is set may monitor the specific RS in the resources (attempt may be made to detect RS). When the specific RS is detected (e.g., received power of specific RS exceeds threshold), UE may regard the aperiodic traffic as being triggered. UE may detect which of a plurality of specific RSs has been transmitted by maximum likelihood (ML) detection, and recognize information on the presence or absence of the occurrence of an event, an event type associated with each of the plurality of specific RSs, and the like based on the detection result. UE may be preset with at least one of resources of a specific RS, a specific sequence, a starting position in the specific sequence, and a cyclic shift of the specific sequence by at least one of a system information block (SIB) and radio resource control (RRC).

UE may be set with A-CSI-RS resources to a UE group for the aperiodic traffic. UE may be set with a periodic resource (monitoring occasion) for the aperiodic traffic, and monitor a specific RS in the resource.

For the aperiodic traffic from UE to the base station (UL), UE may be preset with specific PEACH resources for the aperiodic traffic by higher layer signaling. UE that has detected the occurrence of an event may transmit PRACH by using the specific PRACH resources. The base station may recognize the presence or absence of the occurrence of an event by determining whether or not PRACH has been transmitted (received power exceeding a given threshold has been detected) in the specific PEACH resource. The base station may detect which of a plurality of PRACHs has been transmitted by using maximum likelihood (ML) detection, and recognize information on the presence or absence of the occurrence of an event, an event type associated with each of the plurality of PRACHs, and the like based on the detection result.

According to the option 1-3, a reference signal is transmitted without using paging, and scheduling in response to the occurrence of aperiodic traffic, so that the delay time from the occurrence to the transmission of the aperiodic traffic can be inhibited. When a specific reference signal is transmitted to one transmission destination, a specific transmission destination can be controlled. When common reference signals are transmitted to a plurality of transmission destinations, control in which the plurality of destinations is synchronized can be performed.

### Second Embodiment

Contents included in a container for aperiodic traffic will be described. UE may receive a container for the aperiodic traffic, and decode contents (at least one message) included in the container. The contents may be one of the following options 2-1 and 2-2.

«Option 2-1»

The content for the aperiodic traffic may be one message.

The message may have only a simple content. For example, the message may indicate an error. UE may be preset with an operation corresponding to the message. When receiving the message. UE may perform the set operation. The message may only indicate the occurrence of an event. The message may be 1 bit or more than 1 bit. The simple content of the message reduces the time length of the aperiodic traffic, which increases reliability.

The message may have only a detailed content. For example, the message may indicate at least one of the content of an error and the operation of UE that has received the message. The message may be 2 bits or more. The detailed content may indicate one of a plurality of levels of an error and the like, one of a plurality of events, or one of a plurality of operations performed in response to the message.

The option 2-1 may be combined with the first embodiment. That is, one message may be transmitted by using one of the options 1-1 to 1-3.

According to the option 2-1, overhead can be inhibited by transmitting one message.

«Option 2-2»

The content for the aperiodic traffic may be two or more messages.

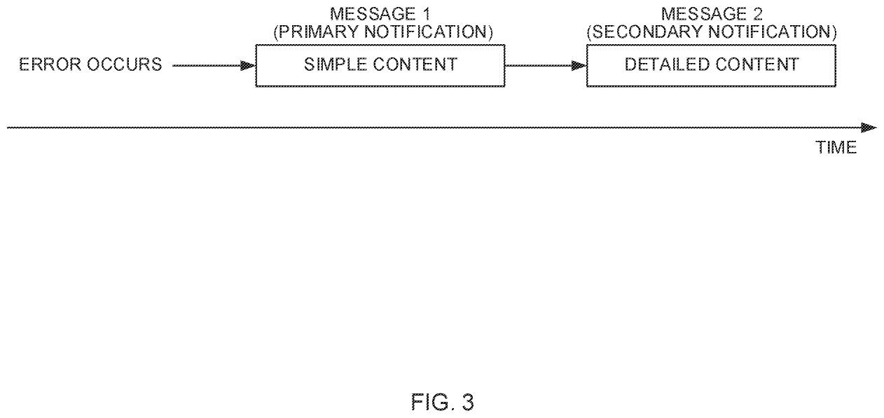

The content for the aperiodic traffic may be two message. As illustrated in FIG. 3, a message 1 (primary notification) of two messages may have a simple content, and a message 2 (secondary notification) may have a detailed content. Each message may be transmitted by different containers (e.g., different PDSCHs).

For example, when an error occurs as the aperiodic traffic, the base station may transmit the message 1 indicating that an error has occurred, and then transmit the message 2 indicating an error level.

The option 2-2 may be combined with the first embodiment. That is, either of the options 1-1 to 1-3 may be used to transmit the messages 1 and 2.

For example, the message 1 may be broadcast data or multicast data, and the message 2 may be unicast data. For example, simple content may be transmitted to a plurality of pieces of UE as the message 1, and detailed content may be transmitted to specific UE among the plurality of pieces of UE as the message 2. The simple content may give an instruction to stop. The detailed content may relate to UE specific control or control over a group smaller than a transmission destination of broadcast data or multicast data.

For example, the message 1 may be transmitted by PDCCH, and the message 2 may be transmitted by PDSCH. For example, the message 1 may be DCI including a flag (field) indicating that the message 1 is aperiodic traffic (e.g, message for IIoT). The message 2 may be carried by the PDSCH scheduled by the DCI, and include detailed information (e.g., error level and error type).

Both the message 1 and the message. 2 may be transmitted by PDSCH. The message 1 and the message 2 may be transmitted by the same one PDSCH or two different PDSCHs. Both the message 1 and the message 2 may be transmitted by PDCCH. The message 1 and the message 2 may be transmitted by the same one PDCCH or two different PDCCHs.

For UL aperiodic traffic, UE may transmit the message 1 indicating the presence or absence of the occurrence of an event by using PRACH as specific RS. UE may further transmit the message 2 indicating detailed information on the event by UL transmission (PUCCH or PUSCH) after Msg3.

According to the option 2-2, two or more messages are transmitted. While overhead and delay time of transmission of the first message is inhibited, the second and subsequent messages can increase an information amount.

### Third Embodiment

UE may support aperiodic traffic in at least one of a connected mode (RRC_CONNECTED), an inactive mode (RRC_INACTIVE), and an idle mode (RRC_IDLE).

For example, UE in the idle mode or the inactive mode may monitor a signal based on aperiodic traffic, such as PDCCH and a reference signal, in resources such as monitoring occasions for each DRX period. When resources of common search space and the like are set, UE in the connected mode may monitor a signal based on the aperiodic traffic, such as PDCCH and a reference signal, in the resources.

According to the third embodiment, UE in the idle mode or the inactive mode performs DRX, so that the power consumption can be inhibited, and information can be received in response to the occurrence of the aperiodic traffic.

(Radio Communication System)

The configuration of a radio communication system according to one embodiment of the present disclosure will be described below. In the radio communication system, communication is performed by using one or a combination of the above-described radio communication methods according to the embodiments of the present disclosure.

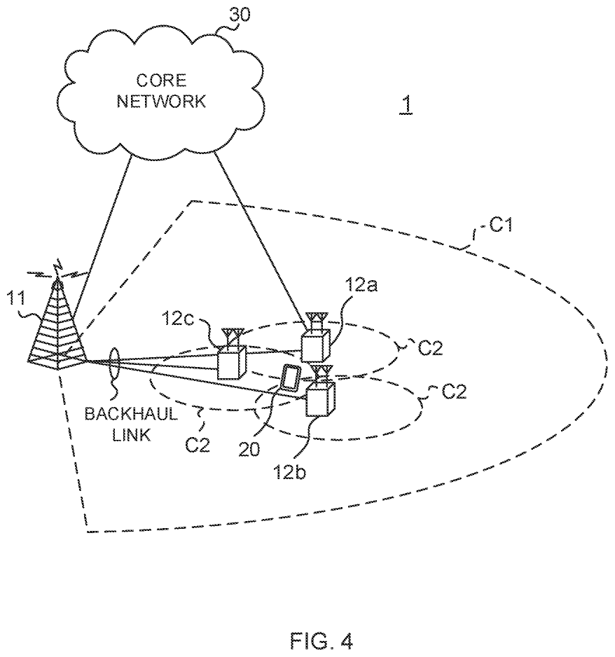

FIG. 4 illustrates one example of a schematic configuration of a radio communication system according to one embodiment. A radio communication system 1 may implement communication by using long term evolution (LTE), specified by a third generation partnership project (3GPP), 5th generation mobile communication system new radio (5G NR), and the like.

The radio communication system 1 may support dual connectivity (multi-RAT dual connectivity (MR-DC)) between a plurality pieces radio access technology (RAT). MR DC may include dual connectivity between LTE (evolved universal terrestrial radio access (E-UTRA)) and NR (E-UTRA-NR dual connectivity (EN-DC)) and dual connectivity between NR and LTE (NR-E-UTRA dual connectivity (NE-DC)).

In EN-DC, an LTE (E-UTRA) base station (eNB) is a master node (MN), and an NR base st on (gNB) is a secondary node (SN). in NE-DC, the NR base station (gNB) is MN, and an LTE (E-UTRA) base station (eNB) is SN.

The radio communication system 1 may support dual connectivity between a plurality of base stations in the same RAT (e.g., dual connectivity in which both MN and SN are NR base stations (gNB) (NR-NR dual connectivity (NN-DC)).

The radio communication system 1 may include a base station 11 and base stations 12 (12a to 12c). The base station 11 forms a macro cell C1 with a relatively wide coverage. The base stations 12 (12a to 12c) are disposed in the macro cell C1, and form a small cell C2 narrower than the macro cell C1. A user terminal 20 may he positioned in at least one cell. The arrangement, number, and the like of each cell and the user terminal 20 are not limited to the aspect in the figure. The base stations 11 and 12 will be collectively referred to as base stations 10 unless these base stations are distinguished from each other.

The user terminal 20 may be connected to at least one of the plurality of base stations 10. The user terminal 20 may use at least one of carrier aggregation (CA) using a plurality of component carriers (CC) and dual connectivity (DC).

Each CC may be included in at least one of a first frequency range (frequency range 1 (FR1)) and a second frequency range (frequency range 2 (FR2)). The macro cell C1 may be included in FR1, and the small cell C2 may be included in FR2. For example, FR1 may be a frequency band of 6 GHz or less (sub-6 GHz), and FR2 may be a frequency band higher than 24 GHz (above-24 GHz). Note that the frequency bands, definitions, and the like of FR1 and FR2 are not limited thereto, and FR1 may correspond to a frequency band higher than FR2, for example.

The user terminal 20 may perform communication in each CC by using at least one of time division duplex (TDD) and frequency division duplex (FDD).

The plurality of base stations 10 may be connected by wire (e.g., optical fiber in compliance with common public radio interface (CPRI) or an X2 interface) or by radio (e.g., NR communication). For example, when NR communication is used as backhaul between the base stations 11 and 12, the base station 11 corresponding to a higher-level station may be referred to as an integrated access backhaul (IAB) donor, and the base station 12 corresponding to a relay station (relay) may be referred to as an LAB node.

A base station 10 may be connected to a core network 30 via another base station 10 or directly. The core network 30 may include at least one of, for example, an evolved packet core (EPC), a 5G core network (5GCN), and a next generation core (NGC).

The user terminal 20 may follow at least one of communication methods such as LTE, LTE-A, and 5G.

In the radio communication system 1, a radio access method based on orthogonal frequency division multiplexing (OFDM) may be used. For example, in at least one of downlink (DL) and uplink (UL), cyclic prefix OFDM (CP-OFDM), discrete Fourier transform spread OFDM (DFT-s-OFDM), orthogonal frequency division multiple access (OFDMA), single carrier frequency division multiple access (SC-FDMA), and the like may be used.

The radio access method may be referred to as a waveform. Note that, in the radio communication system 1, another radio access method (e.g., another single carrier transmission method and another multi-carrier transmission method) may be used as UL and DL radio access methods.

In the radio communication system 1, a physical downlink shared channel (PDSCH) shared by each user terminal 20, a physical broadcast channel (PBCH), physical downlink control. channel (PDCCH), and the like may be used as downlink channels.

In the radio communication system 1, a physical uplink shared channel (PUSCH) shared by each user terminal 20, a physical uplink control channel (PUCCH), a physical random access channel (PRACH), and the like may be used as uplink channels.

User data, higher layer control information, a system information block (SIB) are transmitted by PDSCH. User data, higher layer control information, and the like may be transmitted by PUSCH. Master information block (MIB) may be transmitted by PBCH.

Lower layer control information may be transmitted by PDCCH. The lower layer control information may include, for example, downlink control information (DCI) including scheduling information of at least one of PDSCH and PUSCH.

Note that DCI that schedules PDSCH may be referred to as DL assignment, DL DCI, and the like, and DCI that schedules PUSCH may be referred to as UL grant, UL DCI, and the like. Note that PDSCH may be replaced with DL data, and PUSCH may be rep aced with UL data.

A control resource set (CORESET) and search space may be used to detect PDCCH. CORESET corresponds to a resource for searching for DCI. The search space follows a search area of PDCCH candidates and a search method. One CORESET may be associated with one or plurality of pieces of search space. UE may monitor CORESET associated with certain search space based on search space settings.

One piece of search space may correspond to a PDCCH candidate corresponding to one or a plurality of aggregation levels. One or a plurality of pieces of search space may be referred to as a search space set. Note that “search space”, “search space set”, “search space settings”, “search space set settings”, “CORESET”, “CORESET settings”, and the like in the present disclosure may be replaced with each other.

Uplink control information (UCI) including at least one of channel state information (CSI), delivery confirmation information (e.g., hybrid automatic repeat request acknowledgment (HARQ-ACK), which may be referred to as ACK/NACK and the like), and scheduling request (SR) may be transmitted by PUCCH. A random access preamble for establishing connection with a cell may be transmitted by PRACH.

Note that, in the present disclosure, downlink, uplink, and the like may be expressed without “link”. Various channels may be expressed without “physical” at the beginning thereof.

In the radio communication system 1, a synchronization signal (SS), a down ink reference signal (DL-RS), and the like may be transmitted. In the radio communication systems 1, a cell-specific reference signal (CRS), a channel state information reference signal (CSI-RS), a demodulation reference signal (DMRS), a positioning reference signal (PRS), a phase tracking reference signal (PTRS), and the like may be transmitted as DL-RS.

The synchronization signal may be at least one of, for example, a primary synchronization signal (PSS) and a secondary synchronization signal (SSS). A signal block including SS (PSS and SSS) and PBCH (and DMRS for PBCH) may be referred to as an SS/PBCH block, an SS Block (SSB), and the like. Note that SS, SSB, and the like may also be referred to as a reference signal.

In the radio communication system 1, a sounding' reference signal (SRS), a demodulation reference signal (DMRS), and the like may be transmitted as an uplink reference signal (UL-RS). Note that, DMRS may be referred to as a user terminal-specific reference signal (UE-specific Reference signal).

(Base Station)

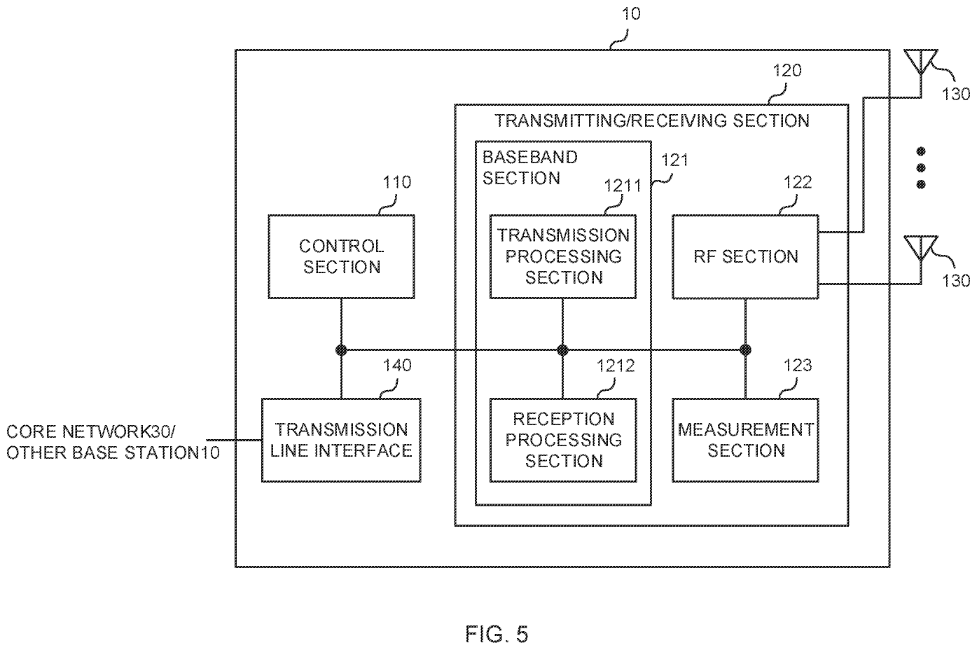

FIG. 5 illustrates one example of the configuration of a base station according to one embodiment. The base station 10 includes a control section 110, a transmitting/receiving section 120, transmission/reception antenna 130, and a transmission line interface 140. Note that one or more control sections 110, one or more transmitting/receiving sections 120, one or more transmission/reception antennas 130, and one or more transmission line interfaces 140 may be provided.

Note that the example mainly describes functional blocks of characteristic parts in the embodiment, and it may be assumed that the base station 10 also includes other functional blocks necessary for radio communication. A part of processing of each section described below may he omitted.

The control section 110 controls the entire base station 10. The control section 110 can be constituted by a controller, a control circuit, and the like, which are described based on common recognition in the technical field according to the present disclosure.

The control section 110 may control signal generation, scheduling (e.g., resource allocation and mapping), and the like. The control section 110 may control transmission measurement and the like using the transmitting/receiving section 120, the transmission/reception antenna 130, and transmission line interface 140. The control section 110 may generate data to be transmitted as a signal, control information, a sequence, and the like, and may transfer the data, the control information, the sequence, and the like to the transmitting/receiving section 120. The control section 110 may perform call processing (e.g., setting and releasing) of a communication channel, management of the state of the base station 10, and management of radio resources.

The transmitting/receiving, section 120 may include a baseboard section 121, a radio frequency (RF) section 122, and a measurement section 123. The baseboard section 121 may include a transmission processing section 1211 and a reception processing section 1212. The transmitting/receiving section 120 can be constituted by a transmitter/receiver, an RT circuit, a baseboard circuit, a filter, a phase shifter, a measurement circuit, transmission/reception circuit, and the like, which are described based on common recognition in the technical field according to the present disclosure.

The transmitting/receiving section 120 may be constituted as an integrated transmitting/receiving section, or may include a transmitting section and a receiving section. The transmitting section may include the transmission processing section 1211 and the d section 122. The receiving section may include the reception processing section 1212, the RF section 122, and the measurement section 123.

The transmission/reception antenna 130 can include an antenna described based on common recognition in the technical field according to the present disclosure, for example, an array antenna.

The transmitting/receiving section 120 may transmit the above-described downlink channel, synchronization signal, downlink reference signal, and the like. The transmitting/receiving section 120 may receive. the above-described uplink channel, uplink reference signal, and the like.

The transmitting/receiving section 120 may form at least one of a transmission beam and a reception beam by using digital beam forming (e.g., precoding), analog beam forming (e.g., phase rotation), and the like.

The transmitting/receiving section 120 (transmission processing section 1211) may perform packet data convergence protocol (PDCP) layer processing, radio link control (RLC) layer processing (e.g., RLC retransmission control), medium access control (MAC) layer processing (e.g., HARQ retransmission control), and the like on data, control information, and the like acquired from the control section 110 to generate a bit string to be transmitted.

The transmitting/receiving section 120 (transmission processing section 1211) may perform transmission processing such as channel encoding (which may include error correction encoding), modulation, mapping, filter processing, discrete Fourier transform (DFT) processing (if necessary), inverse fast Fourier transform (IFFT) processing, precoding, digital-analog conversion, and the like on a string to be transmitted, and output a baseboard signal.

The transmitting/receiving section 120 (RF section 122) may perform modulation to a radio frequency band, filter processing, amplification, and the like on the baseboard signal, and may transmit a signal in the radio frequency band via the transmission/reception antenna 130.

In contrast, the transmitting/receiving section 120 (RF section 122) may perform amplification, filter processing, demodulation to a baseboard signal, and the like on the signal in the radio frequency band received by the transmission/reception antenna 130.

The transmitting/receiving section 120 (reception processing section 1212) may apply reception processing such as analog-digital conversion, fast Fourier transform (FFT) processing, inverse discrete Fourier transform (IDFT) processing (if necessary), filter processing, demapping, demodulation, decoding (which may include error correction decoding), MAC layer processing, RLC layer processing, PDCP layer processing, and the like on the acquired baseboard signal, and acquire user data and the like.

The transmitting/receiving section 120 (measurement section 123) may measure a received signal. For example, the measurement section 123 may perform Radio Resource Management (RRM) measurement, Channel State Information (CSI) measurement, and the like based on the received signal. The measurement section 123 may measure received power (e.g., reference signal received power (RSRP)), received quality (e.g., reference signal received quality (RSRQ), signal to interference plus noise ratio (SINR), signal to noise ratio (SNR)), signal strength (e.g., received signal strength indicator (RSSI)), propagation line information (e.g., CSI), and the like. The measurement result may be output to the control section 110.

The transmission line interface 140 may transmit/receive (perform backhaul signaling on) a signal to and from an apparatus in the core network 30, other base stations 10, and the like, and may, for example, acquire and transmit user data (user plane data), control plane data, and the like for the user terminal 20.

Note that the transmitting section and the receiving section of the base station 10 in the present disclosure may include at least one of the transmitting/receiving section 120 and the transmission/reception antenna 130.

Note that the transmitting/receiving section 120 may transmit at least one signal of a combination of at least one of broadcast data and multicast data and unicast data control information (e.g., PDCCH and PUCCH), and a reference signal (e.g., specific RS) in accordance with traffic that aperiodically occurs (e.g., aperiodic traffic, error, and emergency). The transmitting/receiving section 120 may receive at least one signal of a combination of at least one of broadcast data and multicast data and unicast data, control information (e.g., PDCCH and PUCCH), and a reference signal (e.g., specific RS) in accordance with traffic that aperiodically occurs (e.g., aperiodic traffic, error, and emergency).

(User Terminal)

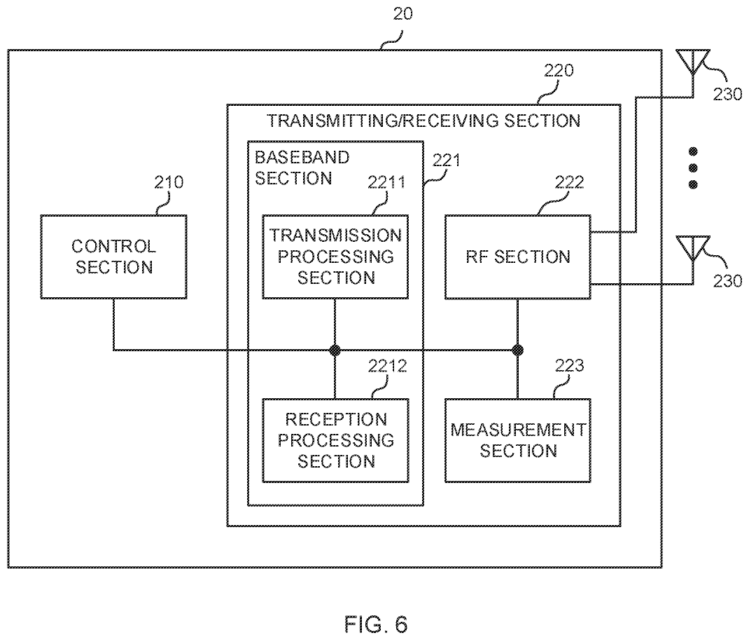

FIG. 6 illustrates one example of tie configuration of a user terminal according to one embodiment. The user terminal 20 includes a control section 210, transmitting/receiving section 220, and a transmission/reception antenna 230. Note that one or more control sections 210, one or more transmitting/receiving sections 220, and one or more transmission/reception antennas 230 may be provided.

Note that the example mainly describes functional blocks or characteristic parts in the embodiment, and it may be assumed that the user terminal 20 also includes other functional blocks necessary for radio communication. A part of processing of each section described below may be omitted.

The control section 210 controls the entire user terminal 20. The control section 210 can include a controller, a control circuit, and the like, which are described based on common recognition in the technical field according to the present disclosure.

The control section 210 may control signal generation, mapping, and the like. The control section 210 may control transmission/reception, measurement, and the like using the transmitting/receiving section 220 and the transmission/reception antenna 230. The control section 210 may generate data to be transmitted as a signal, control information, a sequence, and the like, and may transfer the data, the control information, the sequence, and the like to the transmitting/receiving section 220.

The transmitting/receiving section 220 may include a baseboard section 221, an RF section 222, and a measurement section 223. The baseboard section 221 may include transmission processing section 2211 and a reception processing section 2212. The transmitting/receiving section 220 can include a transmitter/receiver, an RF circuit, a baseboard circuit, a filter, a phase shifter, a measurement circuit, a transmission/reception circuit, and the like, which are described based on common recognition in the technical field according to the present disclosure.

The transmitting/receiving section 220 may be constituted as an integrated transmitting/receiving section, or may include a transmitting section and a receiving section. The transmitting section may include the transmission processing section 2211 and the RF section 222. The receiving section may include the reception processing section 2212, the RF section 222, and the measurement section 223.

The transmission/reception antenna 230 can include an antenna described based on common recognition in the technical field according to the present disclosure, for example, an array antenna.

The transmitting/receiving section 220 may receive the above-described downlink channel, synchronization signal, downlink reference signal, and the like. The transmitting/receiving section 220 may transmit the above-described uplink channel, uplink reference signal, and the like.

The transmitting/receiving section 220 may form at least one of a transmission beam and a reception beam by using digital beam forming (e.g., precoding), analog beam forming (e.g., phase rotation), and the like.

The transmitting/receiving section 220 (transmission processing section 2211) may perform PDCP layer processing, RLC layer processing (e.g., RLC retransmission control), MAC layer processing (e.g., HARQ retransmission control), and the like on, for example, data acquired from the control section 210, control information, and the like to generate a bit string to be transmitted.

The transmitting/receiving section 220 (transmission processing section 2211) may perform transmission processing such as channel encoding (which may include error correction encoding), modulation, mapping, filtering processing, DFT processing (if necessary), IFFT processing, precoding, and digital-analog conversion on a bit string to be transmitted, and may output a baseboard signal.

Note that whether or not to apply DFT processing may be determined based on settings of transform precoding. When transform precoding is enabled for a channel (e.g., PUSCH), the transmitting/receiving section 220 (transmission processing section 2211) may perform DFT processing as the above-described transmission processing in order to transmit the channel by using a DFT-s-OFDM waveform. If not, the transmitting/receiving section 220 (transmission processing section 2211) is not required to perform DFT processing as the above-described transmission processing.

The transmitting/receiving section 220 (RF section 222) may perform modulation to a radio frequency band, filtering processing, amplification, and the like on a baseboard signal, and may transmit the signal in the radio frequency band via the transmission/reception antenna 230.

In contrast, the transmitting/receiving section 220 (RF section 222) may perform amplification, filtering processing, demodulation to a baseboard signal, and the like on the signal in the radio frequency band received by the transmission/reception antenna 230.

The transmitting/receiving section 220 (reception processing section 2212) may acquire user data and the like by applying reception processing such as analog-digital conversion, FFT processing, IDFT processing (if necessary), filter processing, demapping, demodulation, decoding (which may include error correction decoding), MAC layer processing, RLC layer processing, and PDCP layer processing on the acquired baseband signal.

The transmitting/receiving section 220 (measurement section 223) may measure the received signal. For example, the measurement section 223 may perform RRM measurement, CSI measurement, and the like based on the received signal. The measurement section 223 may measure received power (e.g. RSRP), received quality (e.g., RSRQ, SINR, and SNR), signal strength (e.g., RSSI), propagation line information (e.g., CSI), and the like. The measurement result may be output to the control section 210.

Note that the transmitting section and the receiving section of the user terminal 20 in the present disclosure may include at least one of the transmitting/receiving section 220, the transmission/reception antenna 230, and a transmission line interface 240.

Note that the transmitting/receiving section 220 may receive at least one signal of a combination of at least one of broadcast data and multicast data and unicast data, control information (e.g., PDCCH and PUCCH), and a reference signal (e.g., specific RS) in accordance with traffic that aperiodically occurs (e.g., aperiodic traffic, error, and emergency). The control section 210 may decode at least one message (simple content) from the at least one signal.

The at least one signal may include the combination. The combination may include one of the broadcast data scheduled by using downlink control information common to cells (e.g., DCI having a CRC scrambled by RNTI common to cells) and the multicast data scheduled by downlink control information common to groups of user terminal (e.g., DCI haying CRC scrambled by RNTI common to groups).

The at least one signal may include the control information. The control section 210 may decode the control information by using at least one of the identifier for the traffic (e.g., RNTI) and the field for the traffic.

The at least one signal may include the reference signal (specific RS). The reference signal may be based on a sequence (specific sequence) for the traffic.

The at least one message may include information indicating the occurrence of a specific event.

Note that the transmitting/receiving section 220 may transmit at least one signal of a combination of at least one of broadcast data and multicast data and unicast data, control information (e.g., PDCCH and PUCCH), and a reference signal (e.g., specific RS) in accordance with traffic that aperiodically occurs (e.g., aperiodic traffic, error, and emergency). The control section 210 may generate the at least one signal indicating at least one message (simple content).

The at least one signal may include the combination. The combination may include one of the broadcast data scheduled by using downlink control information common to cells (e.g., DCI having a CRC scrambled by RNTI common to cells) and the multicast data scheduled by downlink control information common to groups of user terminal (e.g., DCI having CRC scrambled by RNTI common to groups).

The at least one signal may include the control information. The control section 210 may generate the control information by using at least one of the identifier for the traffic (e.g., RNTI) and the field for the traffic.

The at least one signal may include the reference signal (specific RS). The reference signal may be based on a sequence (specific sequence) for the traffic.

The at least one message may include information indicating the occurrence of a specific event.

(Hardware Configuration)

Note that the block diagrams that have been used to describe the above-described embodiments illustrate blocks in functional units. These functional blocks (configuration units) may be implemented in any combination of at least one of hardware and software. A method of implementing each functional block is not particularly limited. That is, each functional block may be implemented by a physically or logically coupled single apparatus, or may be implemented by directly or indirectly connecting two or more physically or logically separate apparatuses (e.g., by wires, radio, and the like) and using the plurality of apparatuses. The functional blocks may be implemented by combining software with the one apparatus or the plurality of apparatuses.

Here, the functions include, but are not limited to, judging, determination, decision, calculation, computation, processing, derivation, investigation, search, confirmation, reception, transmission, output, access, solution, selection, choosing, establishment, comparison, assumption, expectation, deeming, broadcasting, notifying, communicating, forwarding, configuring, reconfiguring, allocating, mapping, and assigning. For example, a functional block (configuration unit) that causes transmission to function may be called a transmitting section (transmitting unit), a transmitter, and the like. In any case, as described above, the implementation method is not particularly limited.

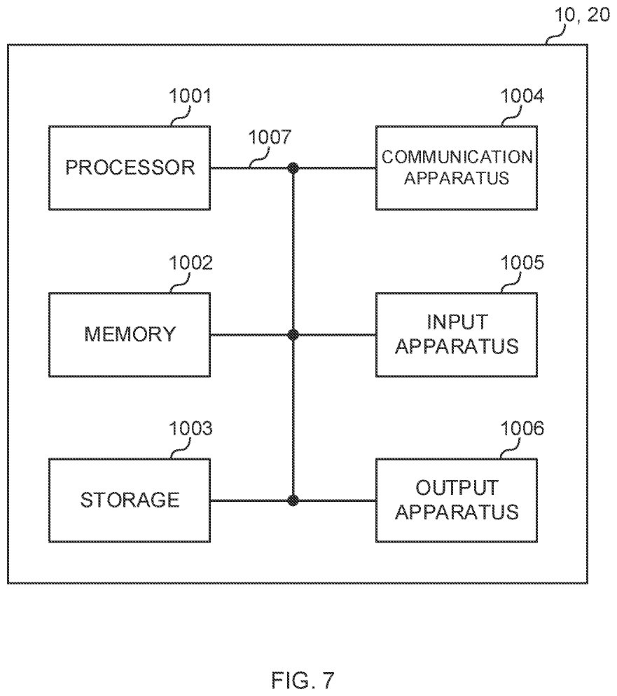

For example, a base station, a user terminal, and the like according to one embodiment of the present disclosure may function as a computer that executes the processing of the radio communication method of the present disclosure. FIG. 7 illustrates one example of the hardware configuration of a base station and a user terminal according to one embodiment. The above-described base station 10 and user terminal 20 may be physically configured as a computer apparatus including a processor 1001, a memory 1002, a storage 1003, a communication apparatus 1004, an input apparatus 1005, an output apparatus 1006, a bus 1007, and the like.

Note that, in the present disclosure, the wording such as an apparatus, a circuit, a device, and a section, and a unit can be replaced with each other. The base station 10 and the user terminal 20 may have the hardware configuration with one or a plurality of apparatuses in the figure or without some apparatuses.

For example, although only one processor 1001 is illustrated, a plurality of processors may be provided. One processor may execute processing, and two or more processors may execute the processing simultaneously, sequentially, or tier another method. Note that the processor 1001 may be implemented with one or more chips.

Each function of the base station 10 and the user terminal 20 is implemented by the processor 1001. For example, the processor 1001 performs operations by causing a predetermined software (program) to be read on hardware such as a memory 1002 to control communication via a communication apparatus 1004 and control at least one of reading and writing of data in the memory 1002 and a storage 1003.

The processor 1001 controls the entire computer by, for example, running an operating system. The processor 1001 may include a central processing unit (CPU) including an interface with peripheral equipment, a control apparatus, an arithmetic apparatus, a register, and the like. For example, at least a part of the above-described control section 110 (210), transmitting/receiving section 120 (220), and the like may be implemented by the processor 1001.

The processor 1001 reads a program (program code), a software module, data, and the like from at least one of the storage 1003 and the communication apparatus 1004 into the memory 1002, and executes various pieces of processing in according therewith. A program to cause a computer to execute at least a part of the operation described in the above-described embodiment is used. For example, the control section 110 (210) may be implemented by a control program that is stored in the memory 1002 and operates in the processor 1001, and other functional blocks may be similarly implemented.

The memory 1002 is a computer-readable recording medium, and may include at least one of, for example, read only memory (ROM), an erasable programmable rum (EPROM), an electrically EPROM (EEPROM), a random access memory (RPM), and other appropriate storage media. The memory 1002 may be referred to as a register, cache, a main memory (slain storage apparatus), and the like. The memory 1002 can store a program (program code), software module, and the like, which can be executed for implementing the radio communication method according one embodiment of the present disclosure.

The storage 1003 is a computer-readable recording med-um, and may include at least one of, for example, a flexible disk, a floppy (registered trademark) disk, a magneto-optical disk (e.g., compact disc (compact disc ROM (CD-ROM) and the like), digital versatile disc, Blu-ray (registered trademark) disk), a removable disk, a hard disk drive, smart card, a flash memory device (e.g., card, stick, and key drive), a magnetic stripe, a database, a server, and other appropriate storage media. The storage 1003 may be referred to as an auxiliary storage apparatus.

The communication apparatus 1004 is hardware (transmission/reception device) for performing inter-computer communication via at least one of a wired network or a radio network, and is referred to as, for example, a network device, a network controller, a network card, and a communication module. The communication apparatus 1004 may include a high frequency switch, a duplexer, a filter, a frequency synthesizer, and the like in order to implement at least one of, for example, frequency division duplex (FDD) and time division duplex (TDD). For example, the above-described transmitting/receiving section 120 (220), transmission/reception tel 130 (230), and the like may be implemented by the communication apparatus 1004. The transmitting/receiving section 120 (220) may be physically or logically implemented by a transmitting section 120a (220a) and a receiving section 120b (220b).

An input apparatus 1005 is an input device (e.g., keyboard, mouse, microphone, switch, button, and sensor) for receiving input from the outside. An output apparatus 1006 is an output device (e.g., display, speaker, and light emitting diode (LED) lamp) for performing output to the outside. Note that the input apparatus 1005 and the output apparatus 1006 may have integrated (e.g., touch panel).

Each apparatus such as the processor 1001 and the memory 1002 is connected by a bus 1007 for communicating information. The bus 1007 may include a single bus or different buses between apparatuses.

The base station 10 and the user terminal 20 may include hardware such as a microprocessor, a digital signal processor (DSP), an application specific integrated circuit (ASIC), a programmable logic device (PLD), and a field programmable gate array (FPGA), and a part or all of each functional block may be implemented by the hardware. For example, the processor 1001 may be implemented with at least one of these pieces of hardware.

(Variations)

Note that terms described in the present disclosure and terms necessary for understanding the present disclosure may be replaced with other terms having the same or similar meaning. For example, a channel, a symbol, and a signal (or signaling) may be replaced with each other. The signal may be a message. A reference signal can be abbreviated as an “RS”, and may be referred to as a “pilot”, a “pilot signal”, and the like depending on a standard to be applied. A component carrier (CC) may be referred to as a cell, a frequency carrier, a carrier frequency, and the like.

A radio frame may include one or a plurality of periods (frames) in a time domain. Each of one or a plurality of periods (frames) constituting a radio frame may be referred to as a subframe. The subframe may include one or a plurality of slots in the time domain. The subframe may be a fixed time length (e.g., 1 ms) that does not depend on numerology.

Here, the numerology may be a communication parameter applied to at least one of transmission and reception of a signal or a channel. For example, the numerology may indicate at least one of subcarrier spacing (SCS), a bandwidth, a symbol length, a cyclic prefix length, a transmission time interval (TTI), the number of symbols per TTI, a radio frame configuration, specific filtering processing performed by a transceiver in a frequency domain, specific windowing processing performed by a transceiver in the time domain, and the like.

The slot may include one or a plurality of symbols (e.g., orthogonal frequency division multiplexing (OFDM) symbol and single carrier frequency division multiple access (SC-FDMA) symbol) in the time domain. The slot may be a time unit based on numerology.

The slot may include a plurality of mind slots. Each mini slot may include one or a plurality of symbols in the time domain. The mind slot may be referred to as a subslot. Each mini slot may include symbols of the number fewer than that of a slot. PDSCH (or PUSCH) transmitted in a time unit larger than a mini slot may be referred to as PDSCH (PUSCH) mapping type A. PDSCH (or PUSCH) transmitted by using a mini slot may be referred to as PDSCH (PUSCH) mapping type B.

All of a radio frame, a subframe, a slot, a mind slot, and a symbol represent a time unit at the time of transmitting a signal. The radio frame, the subframe, the slot, the mini slot, and the symbol may be called by other applicable names. Note that a time unit such as the frame, the subframe, the slot, the mini slot, and the symbol in the present disclosure may be replaced with each other.

For example, one subframe may be referred to as TTI. A plurality of consecutive subframes may be referred to as TTI. One slot or one mini slot may be referred to as TTI. That is, at least one of the subframe and TTI may be a subframe (1 ms) in the existing LTE, a period shorter than 1 ms (e.g., 1 to 13 symbols), or a period longer than 1 ms. Note that a unit that represents TTI may be referred to as a slot, a mini slot, and the like, instead of the subframe.

Here, TTI refers to a minimum time unit of scheduling in radio communication, for example. For example, in LTE systems, the base station performs scheduling of allocating radio resources (e.g., frequency bandwidth and transmission power that can be used in each user terminal) to each user terminal in a TTI unit. Note that the definition of TTI is not limited thereto.

TTI may be a transmission time unit of a channel-encoded data packet (transport block), a code block, a codeword, and the like, or may be a processing unit of scheduling, link adaptation, and the like. Note that, when TTI is given, a time interval (e.g., number of symbols) in which the transport block, the code block, the codeword, and the like are actually mapped may be shorter than TTI.

Note that, when one slot or one mini slot is referred to as TTI, one or more TTIs (i.e., one or more slots or one or more mini slots) may be the minimum time unit of scheduling. The number of slots (number of mini slots) that constitutes the minimum time unit of the scheduling may be controlled.

TTI having a time length of 1 ms may be referred to as usual TTI (TTI in 3GPP Rel. 8 to 12), normal III, long TTI, a usual subframe, a normal subframe, a long subframe, a slot, and the like. TTI shorter than the usual TTI may be referred to as shortened TTI, short TTI, partial TTI (or fractional TTI), a shortened subframe, a short subframe, a mini slot, a subslot, a slot, and the like.

Note that the long TTI (e.g., usual. TTI and subframe) may be replaced with TTI having a time length more than 1 ms, and the short TTI (e.g., shortened TTI) may be replaced with TTI having a TTI length less than the TTI length of the long TTI and not less than 1 ms.

A resource block (RB) is a resource allocation unit in the time domain and the frequency domain, and may include one or a plurality of consecutive subcarriers in the frequency domain. The number of subcarriers in RB may be the same regardless of numerology, and may be 12, for example. The number of subcarriers in RB may be determined based on numerology.

RB may include one or a plurality of symbols in the time domain, and may have a length of one slot, one mini slot, one subframe, or one TTI. Each of one TTI, one subframe, and the like each may include one or a plurality of resource blocks.

Note that one or a plurality of RBs may be referred to as a physical resource block (Physical RB (PRB)), a sub-carrier group (SCG), a resource element group (REG), a PRB pair, an RB pair, and the like.

A resource block may include one or a plurality of resource elements (REs). For example, one RE may be a radio resource domain of one subcarrier and one symbol.

The bandwidth part (BWP) (which may be called partial bandwidth and the like) may represent a subset of consecutive common resource blocks (RB) for certain numerology in a certain carrier. Here, the common RB may be specified by an RB index with reference to a common reference point of the carrier. PRB may be defined by certain BWP, and numbered within the BWP.

BWP may include BWP for UL (UL BWP) and BWP for DL (DL BWP). In UE, one or a plurality of BWPs may be set in one carrier.

At least one or the set BWPs may be active, and UE is not required to assume transmission/reception of a predetermined signal/channel outside the active BWP. Note that cell, carrier, and the like in the present disclosure may be replaced with BWP.

Note that the structures of the above-described radio frame, subframe, slot, mini slot, symbol, and he like are merely examples. For example, configurations of the number of subframes in a radio frame, the number of slots per subframe or radio frame, the number of mini slots in a slot, the number of symbols and RBs in a slot or a mini slot, the number of subcarriers in RB, the number of symbols in TTI, a symbol length, a cyclic prefix (CP) length and the like can be variously changed.

The information, parameters, and the like described in the present disclosure may be represented in an absolute value, represented in a relative value from a predetermined value, or represented by using other corresponding information. For example, radio resources may be specified by a predetermined index.

Names used for parameters and the like in the present disclosure are in no respect limiting. A mathematical expression and the like using these parameters may differ from those explicitly disclosed in the present disclosure. Various channels (e.g., PUCCH and PDCCH) and information elements can be identified by any suitable name. Various names allocated to these various channels and information elements are in no respect limiting.

The information, signals, and the like described in the present disclosure may be represented by using any of various different pieces of technology. For example, data, instructions, commands, information, signals, bits, symbols, chips, and the like, which may be referenced throughout the above description, may be represented by voltages, currents, electromagnetic waves, magnetic fields, magnetic particles, optical fields, optical photons, or any combination thereof.

Information, signals, and the like can be output at least one of from higher layer to lower layer and from lower layer to higher layer. Information, signals, and the like may be input/output via a plurality of network nodes.

The input/output information, signals, and the like may be stored in a specific location (e.g., memory), or may be managed in a control table. The input/output information, signals, and the like can be overwritten, updated, or appended. The output information, signals, and the like may be deleted the input information, signals, and the like may be transmitted to another apparatus.

Information is not required to be reported by a method of an aspect/embodiment described in the present disclosure, and may be reported by another method. For example, in the present disclosure, information may be reported by physical layer signaling (e.g., downlink control information (DCI) and uplink control information (UCI)), higher layer signaling (e.g., radio resource control (RRC) signaling, broadcast information (master information block (MIB), and system information block (SIB)), and medium access control (MAC) signaling), another signal, or a combination thereof.

Note that the physical layer signaling may be referred to as layer 1/layer 2 (L1/L2) control information (L1/L2 control signal), L1 control information (L1 control signal), and the like. The RRC signaling may be referred to as an RRC message, and may be, for example, an RRC connection setup message, an RRC connection reconfiguration message, and the like. The MAC signaling may be reported by using, for example, a MAC control element (CE).

Predetermined information (e.g., “being X”) may be reported not explicitly but implicitly (e.g., by not reporting the predetermined information or by reporting other information).

Decision may be made in a value represented by one bit (0 or 1), in a Boolean value represented by true or false, or by comparing numerical values (e.g., comparison against predetermined value).

Regardless of whether referred to as software, firmware, middleware, microcode, or hardware description language, or referred to by other names, software should be broadly interpreted so as to mean an instruction, an instruction set, a code, a code segment, a program code, a program, a subprogram, a software module, an application, software application, a software package, a routine, a subroutine, an object, an executable file, an execution thread, a procedure, a function, and the like.

The software, instruction, information, and the like may be transmitted/received via a transmission medium. For example, when software is transmitted from a website, a server, or other remote sources by using at least one of wired technology (coaxial cable, optical fiber cable, twisted-pair cable, digital subscriber line (DSL), and the like) or wireless technology (infrared light microwave, and the like), at least one of these wired technology and wireless technology is included in the definition of the transmission medium.

The terms “system” and “network” used in the present disclosure may be compatibly used. The “network” may mean an apparatus (e.g., base station) included in the network.

In the present disclosure, terms such as “precoding”, “precoder”, “weight (precoding weight) ”, “quasi-Co-Location (QCL)”, “transmission configuration indication state (TCI state)”, “spatial relation”, “spatial domain filter”, “transmission power”, “phase rotation”, “antenna port”, “antenna port group”, “layer”, “number of layers”, “rank”, “resource”, “resource set”, “resource group”, “beam”, “beam width”, “beam angle”, “antenna”, “antenna element”, and “panel” can be compatibly used.

In the present disclosure, the terms such as “base station (BS)”, “radio base station”, “fixed station”, “NodeB”, “eNodeB (eNB)”, “gNodeB (gNB)” “access point”, “transmission point (TP)”, “reception point (RP)”, “transmission/reception point (TRP)” “panel”, “cell”, “sector”, “cell group”, “carrier”, “component carrier”, and the like may be compatibly used. The base station may be referred to by a term such as a macro cell, a small cell, femto cell, a pico cell, and the like.

A base station can accommodate one or a plurality of (e.g., three) cells. When a base station accommodates a plurality of cells, the entire coverage area of the base station can be partitioned into a plurality of smaller areas. Each smaller area can provide communication service through a base station subsystem (e.g., indoor small base station (remote radio head (RRH))). The term “cell” or “sector” refers to a part or all of the coverage area of at least one of a base station and a base station subsystem which provide communication service in the coverage.

In the present disclosure, the terms such as a “mobile station (MS)”, a “user terminal”, “user equipment (UE)”, and a “terminal” can be compatibly used.

A mobile station may be referred to as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or by some other appropriate terms.

At least one of the base station or the mobile station may be referred to as a transmitting apparatus, a receiving apparatus, a radio communication apparatus, and the like. Note that at least one of the base station and mobile station may be a device mounted on a moving object, a moving object itself, and the like. The moving object may be a vehicle (e.g., car and airplane), an unmanned moving object (e.g., drone and autonomous car), or a (manned or unmanned) robot. Note that at least one of the base station and the mobile station includes an apparatus that does not necessarily move during a communication operation. For example, at least one of the base station and the mobile station may be Internet of Things (IoT) device such as a sensor.

The base station in the present disclosure may be replaced with a user terminal. For example, each aspect/embodiment of the present disclosure may be applied to a configuration in which communication between the base station and the user terminal is replaced with communication between a plurality of user terminals (which may be referred to as, for example, device-to-device (D2D) and vehicle-to-everything (V2X). In the case, the user terminal 20 may have a function of the above described base stations 10. The wording such as “up” and “down” may be replaced with the wording corresponding to the communication between terminals (e.g., “side”). For example, an uplink channel and a down link channel may be replaced with a side channel.

Similarly, the user terminal in the present disclosure may e replaced with a base station. In the case, the base stations 10 may have a function of the above-described user terminal 20.

In the present disclosure, an operation performed by a base station may be performed by an upper node thereof in some cases. In a network including one or a plurality of network nodes with a base station, it is clear that various operations performed so as to communicate with a terminal can be performed by a base station, one or a plurality of network nodes (e.g., mobility management entity (MME) and serving-gateway (S-GW) may be possible, but are not limiting) other than the base station, or a combination thereof.

The aspects/embodiments illustrated in the present disclosure may be used independently or in combination, and may be switched along with execution. The processing procedure, sequence, flowchart, and the like of each aspect/embodiment illustrated in the present disclosure may be re-ordered as long as inconsistencies do not arise. For example, in the methods described in the present disclosure, various step elements are presented by using an illustrative order, and the methods are not limited to the presented specific order.

Each aspect/embodiment illustrated in the present disclosure may be applied to a system using long term evolution (LTE), LTE-Advanced (LTE-A), LTE-Beyond (LTE-B), SUPER 3G, IMT-Advanced, 4th generation mobile communication system (4G), 5th generation mobile communication system (5G), future radio access (FRA), new-radio access technology (New-RAT), new radio (NR), new radio access (NX), future generation radio access (FX), global system for mobile communications (GSM (registered trademark)), CDMA 2000, ultra mobile broadband (UMB), IEEE 802.11 (Wi-Fi (registered trademark)), IEEE 802.16 (WiMAX (registered trademark)), IEEE 802.20, ultra-wideband (UWB), Bluetooth (registered trademark), and other appropriate radio communication methods, a next generation system expanded based thereon, and the like. A plurality of Systems may be combined (e.g., combination of LTE or LTE-A and 5G) and applied.

The phrase “based on” used in the present disclosure does not mean “based only on”, unless otherwise specified. In other words, the phrase “based on” means both “based only on” and “based at least on”.

Reference to any element using designations such as “first”, “second”, and the like used in the present disclosure does not generally limit the quantity or order of these elements. These designations may be used in the present disclosure only for convenience, as a method for distinguishing two or more elements. Reference to the first and second elements does not mean that only two elements may be adopted, or that the first element must precede the second element in some way.

The terms “judging (determining)” used in the present disclosure may encompass a wide variety of operations. For example, “judging (determining)” may be regarded as “judging (determining)” judging, calculating, computing, processing, deriving, investigating, looking up, search, inquiry (e.g., looking up in table, database, or another data structure), ascertaining, and the like.

“Judging (determining)” may be regarded as “judging (determining)” receiving (e.g., receiving information), transmitting (e.g., transmitting information), input, output, accessing (e.g., accessing data in memory), and the like.

“Judging (determining)” may be regarded as “judging (determining)” resolving, selecting, choosing, establishing, comparing, and the like. That is, “judging (determining)” may be regarded as “judging (determining)” some operations.

“Judging (determining)” may be replaced with “assuming”, “expecting”, “considering” and the like.

The “maximum transmission power” described in the present disclosure may mean a maximum value of transmission power, the nominal UE maximum transmit power, or the rated UE maximum transmit power.

The terms “connected” and “coupled”, or any variation thereof used in the present disclosure mean all direct or indirect connections or coupling between two or more elements, and can include the presence of one or more intermediate elements between two elements that are “connected” or “coupled” to each other. The coupling or connection between the elements may be physical, logical, or a combination thereof. For example, “connection” may be replaced with “access”.

In the present disclosure, when two elements are connected, these elements may be considered to he “connected” or “coupled” to each other by using one or more electrical wires, cables, printed electrical connections, and the like, and by using, as some non-limiting and non-inclusive examples, electromagnetic energy having a wavelength in the radio frequency domain, microwave domain, and optical (both visible and invisible) domain, and the like.

In the present disclosure, the phrase “A and B are different” may mean “A and B are different from each other”. Note that the phrase may mean that “Each of A and B is different from C”. The terms such as “leave”, “coupled”, and the like may be interpreted similarly to “different”.

When “include”, “including”, and variations thereof are used in the present disclosure, these terms are intended to be inclusive similarly to the term “comprising”.

The term “or” used in the present disclosure is intended not to be exclusive-OR.

In the present disclosure, when English articles such as “a”, “an”, and “the” are added in translation, the present disclosure may include the plural forms of nouns that follow these articles.

Although the invention according to the present disclosure has been described in detail above, it is obvious to a person skilled in the art. that the invention according to the present disclosure is by no means limited to the embodiments described in the present disclosure. The invention according to the present disclosure can be implemented as corrections and modifications without departing from the spirit and scope of the invention defined based on the claims. The description of the present disclosure is provided for the purpose of exemplification and explanation, and has no limitative meaning to the invention according to the present disclosure.

1. A user terminal comprising:
a receiving section that receives at least one signal of a combination of at least one of broadcast data and multicast data and unicast data, control information, and a reference signal in accordance with traffic that aperiodically occurs; and a control section that decodes at least one message from the at least one signal.

2. The user terminal according to claim 1,
wherein the at least one signal includes the combination, and
the combination includes one of the broadcast data scheduled by downlink control information common to cells and the multicast data scheduled by downlink control information common to groups of user terminal.

3. The user terminal according to claim 1,
wherein the at least one signal includes the control information, and
the control section decodes the control information by using at least one of an identifier for the traffic and a field for the traffic.

4. The user terminal according to claim 1, wherein the at least one signal includes the reference signal, and the reference signal is based on a sequence for the traffic.

5. The user terminal according to claim 1, wherein the at least one message includes information indicating occurrence of a specific event.

6. A radio communication method of a user terminal, comprising the steps of:
receiving at least one signal of a combination of at least one of broadcast data and multicast data and unicast data, control information, and a reference signal in accordance with traffic that aperiodically occurs; and
decoding at least one message from the at least one signal.

7. The user terminal according to claim 2,
wherein the at least one signal includes the control information, and
the control section decodes the control information by using at least one of an identifier for the traffic and a field for the traffic.

8. The user terminal according to claim 2, wherein the at least one signal includes the reference signal, and the reference signal is based on a sequence for the traffic.

9. The user terminal according to claim 3, wherein the at least one signal includes the reference signal, and the reference signal is based on a sequence for the traffic.

10. The user terminal according to claim 2, wherein the at least one message includes information indicating occurrence of a specific event.

11. The user terminal according to claim 3, wherein the at least one message includes information indicating occurrence of a specific event.

12. The user terminal according to claim 4, wherein the at least one message includes information indicating occurrence of a specific event.
